(19) United States
(12) Patent Application Publication
(10) Pub. No.: US 2009/0245798 A1
(43) Pub. Date: Oct. 1, 2009

(54) OPTICAL CIRCUIT AND RECEIVER CIRCUIT

(75) Inventor: Koji TERADA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/409,940

(22) Filed: Mar. 24, 2009

(30) Foreign Application Priority Data
Mar. 25, 2008 (JP) 2008-077537

(51) Int. Cl. H04J 14/02; G02F 1/295; G02F 1/01

(52) U.S. Cl. 398/79; 385/5; 359/276

(57) ABSTRACT

An optical circuit that converts a phase-modulated optical signal into intensity-modulated signal light in accordance with a phase, the optical circuit including a square mode distribution forming portion that forms a plurality of interfering signals each assuming a square mode shape, the interfering signals having respective phases shifted from each other by a certain angle, a light interference portion that creates a signal having a certain mode distribution, from the interfering signal, and that applies a Fourier transform to the signal having the certain mode distribution, and an output portion that has a plurality of waveguides each provided in correspondence with the phase and that outputs an optical signal that has been output from the light interference portion.

### CROSS-REFERENCE TO RELATED APPLICATION

This application is based upon and claims the benefit of priority of the prior Japanese Patent Application No. 2008-077537, filed on Mar. 25, 2008, the entire contents of which are incorporated herein by reference.

### FIELD

The embodiments discussed herein are related to an optical circuit and a receiver circuit. More specifically, the embodiments discussed herein pertain to an optical circuit and a receiver circuit that convert a phase-modulated optical signal into an intensity-modulated signal in accordance with a phase.

### BACKGROUND

As a communications technique using an optical fiber, the wavelength division multiplexing (WDM) technique is well known.

In order to enhance the transmission speed of the prevailing WDM optical transmission system with a bit rate of approximately 10 Gb/s per wavelength, up to approximately 40 Gb/s per wavelength for example, there has been a demand for a modulation method in which a spectrum width at the time of modulation is narrow.

As possible modulation methods meeting the above-described requirement, phase modulation methods such as differential quadrature phase shift keying (DQPSK) and quadrature phase shift keying (QPSK) are known in the art.

For the DQPSK, the phase shift amount from a preceding symbol are assumed to be four kinds: 0, π/2, π, and 3π/2, and for the QPSK, phases of symbols are assumed to be likewise 0, π/2, π, and 3π/2.

Either of these methods allows one symbol to deal with 2-bit information, and hence, at a symbol rate of approximately 20 Gsymbol/s, either of these methods can realize a transmission capacity of approximately 40 Gb/s per wavelength. These methods, therefore, are characterized in that a spectrum width at the time of modulation is narrow (equivalent to 20 G).

Typically, reception with a phase-modulated signal used as an intensity signal is implemented by converting the phase-modulated signal into an intensity modulation (on-off-keying: OOK) signal by subjecting the phase-modulated signal to interference with light having a reference phase.

In the DQPSK, because a phase of the preceding symbol is used as a reference, the phase-modulated signal is converted into the intensity-modulated signal using one symbol delay interference optical circuit referred to as a “demodulator”. On the other hand, in the QPSK, with the phase of light output from a phase reference light source arranged in a receiver as a reference, the received signal light and the light from the light source are mixed by a mixer (for example, a coupler), to thereby convert the phase-modulated signal into the intensity-modulated signal.

In the DQPSK and the QPSK, information of signals is arranged on a phase plan as optical phases (0, π/2, π, and 3π/2), and therefore, in a many kinds of demodulators and mixers, two phase references of which the optical phases are mutually shifted by approximately 90 degrees are generated for use in interference.

In the DQPSK, the received signal is branched, and is input to mutually different delay interferometers of which the delay amounts are mutually different in the optical phase by approximately 90 degrees. On the other hand, in the QPSK, a method is used in which output light of a phase reference light signal is branched, and after having been provided with a light path length difference by approximately 90 degrees of optical phase, the branched output light beams are subjected to interference with an optical signal by respective different mixers.

In each of the above-described demodulator and the mixer, although there exist two places for causing the phase reference light signal and the optical signal to interfere with each other, a configuration has been proposed wherein they interfere with each other at one place alone, as a demodulator for the DQPSK (see for, example, Journal of Lightwave Technology, Vol. 24, No. 1, January, 2006. pp. 171-174 (Lucent)).

This configuration is suitable for size-reduction since we can make do with only one system of delay line, as well as load upon delay amount control can be reduced from two systems to the one system. In the above-described reference document, operations of a modulator for DQPSK have been implemented by a delay interferometer with a single system of delay line using 2×4 star couplers.

However, in the modulator for DQPSK set forth in the above-described document, as a result of interference in a slab waveguide, an interference intensity has been generated also outside an output waveguide. This constitutes stray light components, and has caused a loss commensurable with an amount of the stray light components.

FIG. 11 is a diagram illustrating conventional waveforms after interference.

As illustrated in FIG. 11, an envelope of interference waveforms is a substantially Gaussian distribution, and therefore, in response to securing the uniformity of interference intensity of an output waveguide portion, skirt portions of the distribution run over to the outside of the output waveguide. These portions constitute stray light components, thereby causing a problem of increasing loss of optical signals.

### SUMMARY

An optical circuit that converts a phase-modulated optical signal into intensity-modulated signal light in accordance with a phase modulated, the optical circuit including: a square mode distribution forming portion that forms a plurality of interfering signals each assuming a square mode shape, the interfering signals having respective phases shifted from each other by a certain angle; a light interference portion that creates a signal having a certain mode distribution, from the interfering signal, and that applies Fourier transform to the signal having the certain mode distribution; and an output portion that has a plurality of waveguides each provided in correspondence with the phase and that outputs an optical signal that has been output from the light interference portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an outline of various embodiments;

FIG. 2 illustrates functions of an optical transmission system according to a first embodiment;

FIG. 3 illustrates a configuration of a demodulator according to the first embodiment;

FIG. 4 illustrates an example of configuration of mode conversion portions;

FIG. 5 illustrates patterns of intensities of optical outputs output from waveguides of an output waveguide;

FIG. 6 illustrates distances between waveguides of the output waveguide;

FIG. 7 illustrates waveforms in various portions;

FIG. 8 illustrates waveforms after interference in the present embodiment;

FIG. 9 illustrates a demodulator according to a second embodiment;

FIG. 10 illustrates a mixer according to a third embodiment; and

FIG. 11 illustrates conventional waveforms after interference.

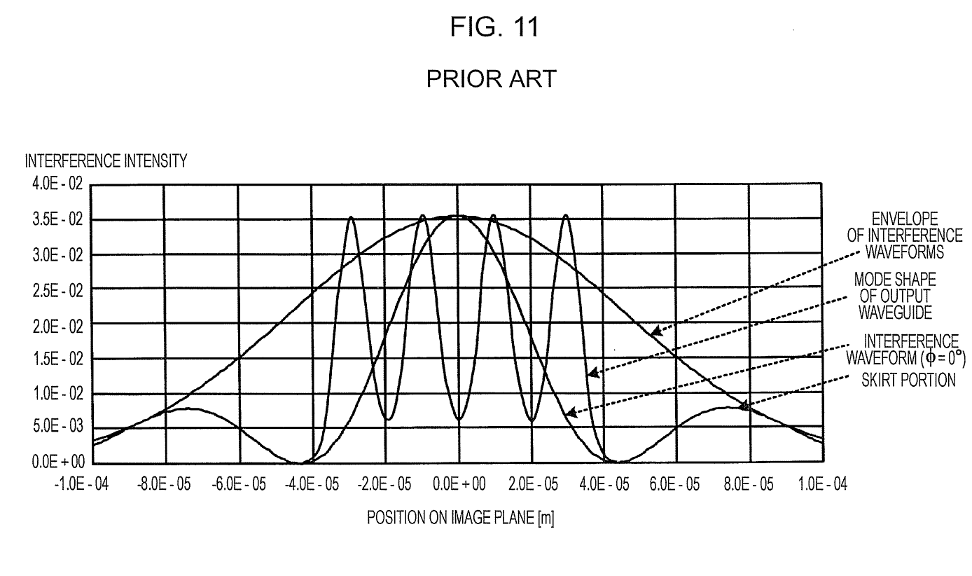

### DESCRIPTION OF EMBODIMENTS

Hereinafter, various embodiments according to the present invention will be described in detail with reference to the accompanying drawings.

First, outlines of embodiments are described, and then details of pertinent embodiments are explained in detail.

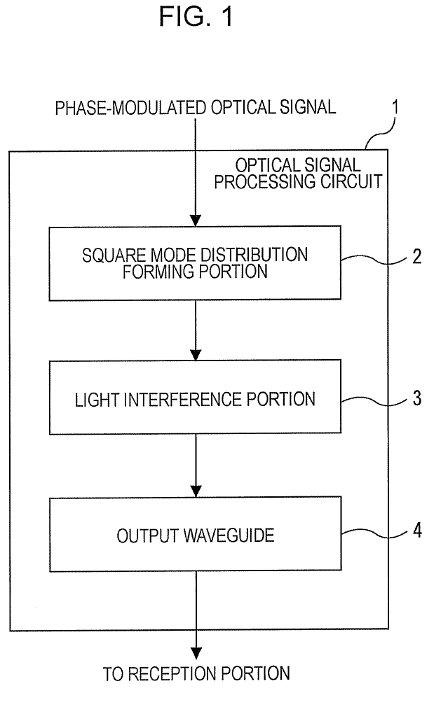

FIG. 1 illustrates an outline of various embodiments.

An optical circuit 1 illustrated in FIG. 1 has a function of converting a phase-modulated optical signal into an intensity-modulated signal in accordance with a phase. The optical circuit 1 includes a square mode distribution forming portion 2, a light interference portion 3, and an output waveguide 4.

The square mode distribution forming portion 2 forms two signals for interference, each having a square mode shape, the two signals being shifted in phase from each other by a certain angle. The square mode shape may exhibit a trapezoid optical intensity distribution having a finite rising region.

For example, when the optical circuit 1 receives an optical signal phase-modulated by the differential quadrature phase shift keying (DQPSK), the square mode distribution forming portion 2 forms a signal for interference (hereinafter, referred to as an “interfering signal”) using the phase-modulated signal and an optical signal obtained by delaying the optical signal by one symbol.

Furthermore, when the optical circuit I receives an optical signal phase-modulated by the quadrature phase shift keying (QPSK), the square mode distribution forming portion 2 forms an interfering signal using an optical signal serving as a phase reference and the phase-modulated optical signal.

The light interference portion 3 creates a signal having a sinc function mode distribution, from the formed interfering signal, and applies a Fourier transform to the signal having the sinc function mode distribution.

The signal with the sinc function mode distribution can be created, for example, by applying a Fourier transform to the square mode distribution created by the interfering signal.

The output waveguide 4 has a plurality of waveguides each provided in correspondence with a phase, and outputs an optical signal having been output from the light interference portion 3 to the outside (reception portion).

According to such an optical circuit 1; an envelope of waveforms after interference assumes a square shape, since the light interference portion 3 applies a Fourier transform to the sinc function mode distribution signal created based on the interfering signal having a square mode shape. This allows prevention of optical components from being output to the outside of the output waveguide 4, leading to reduction in loss of light.

Specific, non-limiting embodiments will be described hereinbelow.

### First Embodiment

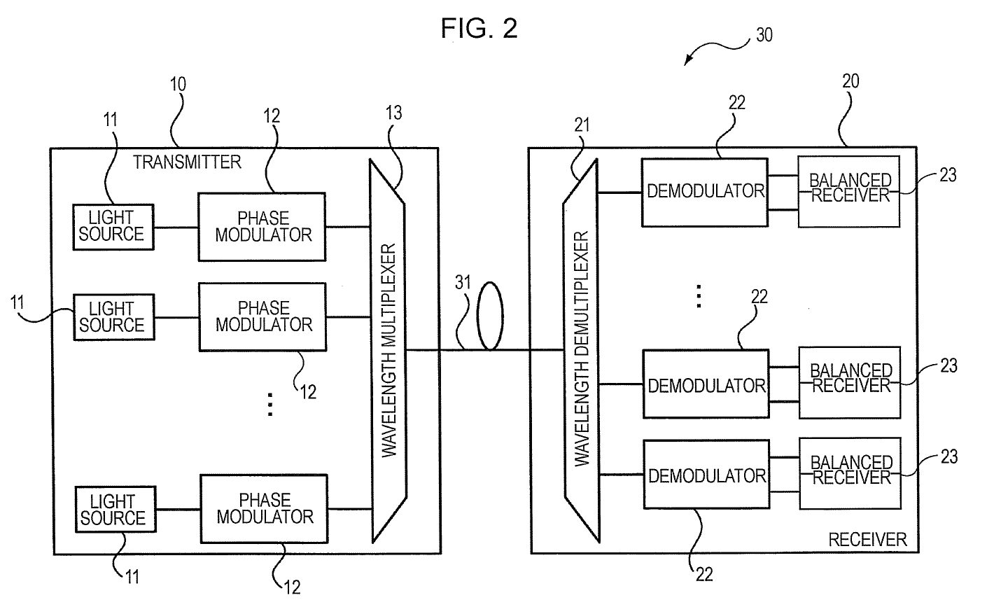

FIG. 2 illustrates functions of an optical transmission system 30 according to a first embodiment.

The optical transmission system 30 includes a transmitter 10 and a receiver 20 that transmit/receive light by the DQPSK method.

The transmitter 10 includes a plurality of light sources 11, a plurality of phase modulators 12, and a wavelength multiplexer 13.

The light sources 11 output optical signals having wavelengths mutually different to their respective phase modulators 12.

The phase modulators 12 convert intensity-modulated signals having been output by the respective light sources 11 into phase-modulated signals of which phases are mutually shifted by approximately 90 degrees.

The wavelength multiplexer 13 multiplexes optical signals having mutually different wavelengths modulated by the respective phase modulators 12, and transmits the multiplexed signal to the receiver 20 through one optical fiber 31.

The receiver 20 includes a wavelength demultiplexer 21, a plurality of demodulators (optical circuit) 22, and a plurality of balanced receivers 23.

The wavelength demultiplexer 21 separates an optical signal that has been input, and outputs the separated input optical signals to the demodulator 22.

Each of the demodulators 22 convert a respective one of the phase-modulated signals that have been input, into a pair of complementary intensity-modulated signals, and outputs the converted signals to the corresponding balanced receivers 23.

Each of the balanced receivers 23 detects a level difference between corresponding positive (in phase)/negative (reverse phase) phases.

A photoelectric conversion portion is constituted by the demodulator 22 and the balanced receivers 23.

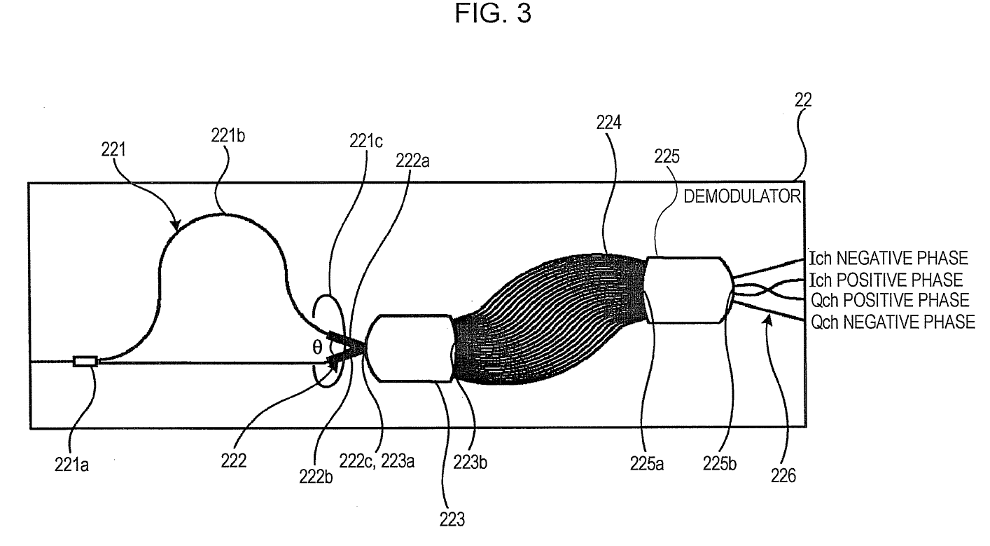

FIG. 3 illustrates a configuration of a demodulator according to the first embodiment.

The demodulator 22 includes a branch delay portion 221, a square mode distribution forming portion 222, a slab waveguide 223, an allay waveguide 224, a slab waveguide 225, and an output waveguide 226 in this order from the left side in FIG. 3.

The branch delay portion 221 includes a 3-dB coupler 221a that branches an optical signal into 1:1, a one-symbol delay portion 221b that delays an optical signal by one symbol, and an input waveguide pair 221c that guide the branched signals to the square mode distribution forming portion 222.

The square mode distribution forming portion 222 includes mode conversion portions 222a and 222b that create a square-shaped envelope (square mode distribution).

Out of signals that have been output from the input waveguide pair 221c, an optical signal delayed by one symbol is input to the mode conversion portion 222a, while an optical signal without delay is input to the mode conversion portion 222b.

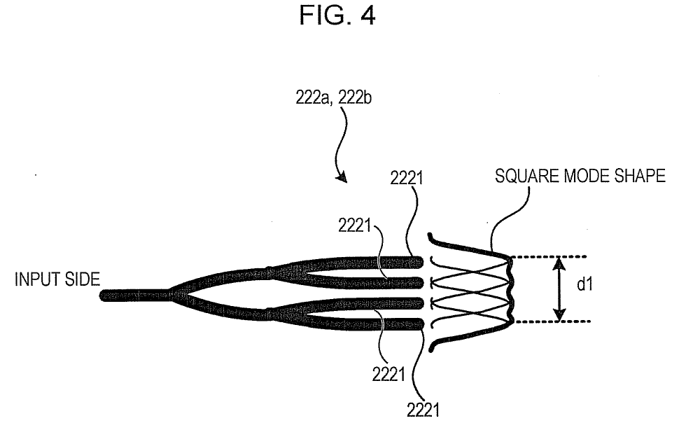

FIG. 4 illustrates an example of a configuration of the mode conversion portions.

The mode conversion portions 222a and 222b are each constituted by overlaying narrow pitched Y-shape branches of the waveguide on each other in a multistage manner, and their exit portions 2221 are made close to each other. As a result, a plurality of (four, in the example in FIG. 4) mode distributions of the waveguide are superimposed together. This allows the creation of a mode distribution (square mode distribution) assuming a shape near a square as a whole.

Now, description will be made returning to FIG. 3.

An output side of the mode conversion portions 222a and 222b constitutes the output portions 222c where they cross each other at one point. The output portions 222c are connected to a central portion 223a on an input side of the slab waveguide 223. As a consequence, outgoing light of the mode conversion portions 222a and outgoing light of the mode conversion portions 222b are made incident on the slab waveguide 223 in a state in which they cross each other at a certain angle, whereby mode distributions can be superimposed together so that a relative phase difference between the signal light and the phase reference light take a value between 0 and 360 degrees in the width of the square mode distribution.

When the width of the flat (deemed as being flat) portion of the square mode shape is designated by d1, and the wavelength of light is designated by λ, it is desirable that a crossing angle θ (refer to FIG. 3) between the mode conversion portions 222a and 222b satisfy the relationship in the following expression (1), or that θ be a little larger (for example, larger by about 10%) than the value determined by the expression (1).

74 /2=(λ/2)/d1 (1)

Under this condition, in the crossing portion between the mode conversion portions 222a and 222b, the relative phase difference between the signal light and the phase reference light varies over the width d1 of the square mode, within a range between 0 and 360 degrees, or within a little wider range inclusive of the foregoing range.

The slab waveguide 223 and the slab waveguide 225 are equal in configuration. An output end of the slab waveguide 223 and an input end of the slab waveguide 225 are connected by the allay waveguide 224 having a plurality of waveguides of which the lengths are equal to each other.

Specifically, the plurality of waveguides of the allay waveguide 224 are connected to the output side of the slab waveguide 223 so that the central portion 223b of the end portion on the output side of the slab waveguide 223 conforms to the center of the input side of the allay waveguide 224, the plurality of waveguides being arranged in a radial fashion. Also, the plurality of waveguides of the allay waveguide 224 are connected to the input side of the slab waveguide 225 so that the central portion 225a of the end portion on the input side of the slab waveguide 225 conforms to the center of the output side of the allay waveguide 224, the plurality of waveguides being arranged in a radial fashion.

The output waveguide 226 includes a plurality of (four, in the example in FIG. 3) waveguides spaced from each other by a certain distance. The output waveguide 226 is arranged in a radial fashion so that the center of positions such that two waveguides folded is superimposed on the two other waveguides conforms to the central portion 225b of the end portion on the output side of the slab waveguide 225.

The waveguides in the output waveguide 226 are arranged in correspondence with a peak position in optical intensity on an image plan varying in accordance with a phase shift from a preceding symbol, and these waveguides output intensity-modulated signals that are input, to the balanced receivers 23. In FIG. 3, starting with the waveguide located at the top, these waveguides output intensity-modulated signals of Ich negative phase (reverse phase), Ich positive phase (in phase), Qch positive phase (in phase), and Qch negative phase (reverse phase) in this order.

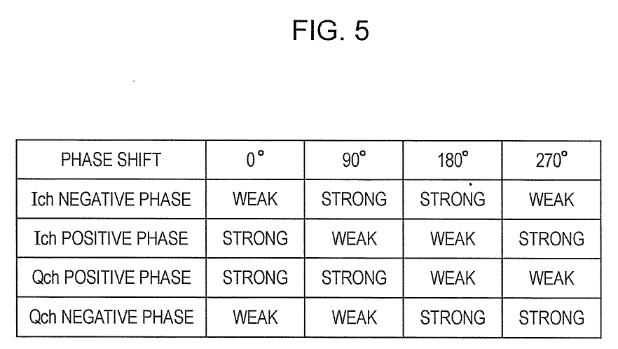

FIG. 5 illustrates patterns of intensities of optical outputs output from the waveguides of the output waveguide.

In FIG. 5, “strong” indicates that the intensity of light is a high level, and “weak” indicates that the intensity of light is a low level. For example, the phase shift is approximately 0 degree, a high level in the light intensity is output from the Ich positive phase (in phase) and the Qch positive phase (in phase), while a low level in the light intensity is output from the Ich negative phase (reverse phase) and the Qch negative phase (reverse phase). In this manner, there exist output patterns of the four optical signals in accordance with mutually different phase shifts, thereby allowing the transmission of four kinds of signals.

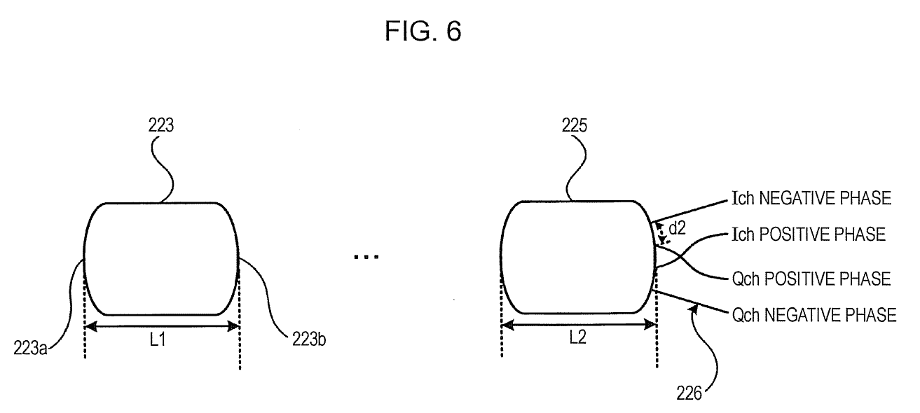

FIG. 6 illustrates distances between waveguides of the output waveguide.

In FIG. 6, the allay waveguide 224 is omitted from illustration.

Let lengths of the slab waveguides 223 and 225 be L1 and L2, respectively (here, for example, the “length” of the slab waveguide 223 means the distance from the central portion 223a of the input side of an optical signal to the central portion 223b on the output side). Then, it is desirable that a distance d2 along an arcuate end face of the slab waveguide 225, between two adjacent waveguides in the output waveguide 226 satisfy the relationship in the following expression (2) using the above-described angle θ.

4×d2=(L2/L1)×λ/θ (2)

Thereby, when phase differences between the signal light and the phase reference light are 0, 90, 180, or 270 degrees, an optical signal intensity-modulated based on the relative intensity relationships illustrated in FIG. 5 can be output to the output waveguide 226.

Next, functions of the demodulator 22 are described in detail.

The demodulator 22 suppresses stray components occurring outside the output waveguide 226 to reduce loss. For this purpose, the demodulator 22 makes up a mode shape (corresponding to an envelope of interference waveforms) of optical signals incident on the vicinity of the input portion of the output waveguide 226 so that intensities of interference waveforms may concentrate on the waveguide portions of the output waveguide 226.

As concrete means therefore, the demodulator 22 makes an envelope of interference waveforms a square shape on the output side of the slab waveguide 225, that is, on the input side of the output waveguide 226, by making the mode shape on the input side of the slab waveguide 225 a sinc function.

Hereinbelow, a more detailed description of functions of the demodulator 22 is given.

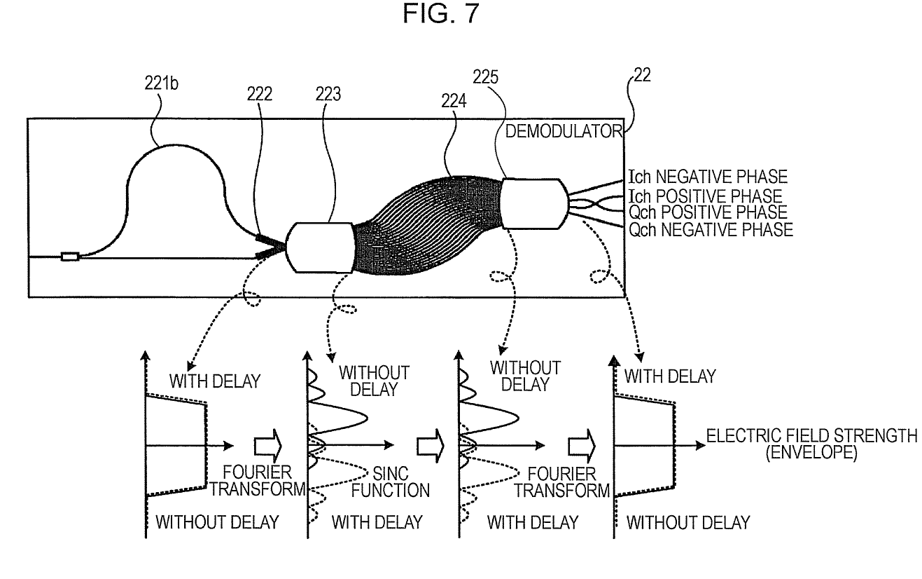

FIG. 7 illustrates waveforms in various portions.

As illustrated in FIG. 4, the square mode distribution forming portion 222 creates a square mode distribution. In FIG. 7, the waveform of an optical signal that has not passed through the one-symbol delay portion 221b is denoted by “without delay”, while the waveform of an optical signal that has passed through the one-symbol delay portion 221b is denoted by “with delay”. Here, for making the figure more legible, the waveform without delay is represented by a solid line while the waveform with delay is represented by a dotted line.

Mode distributions on the input side and the output side of each of the slab waveguides 223 and 225 are in Fourier transform relationship with each other. Therefore, the slab waveguide 223 applies a Fourier transform to a square mode distribution created by the square mode distribution forming portion 222.

When an optical signal is a square wave, the spectrum thereof is a sinc function. That is, as illustrated in FIG. 7, an intensity distribution of each of interference light beams without and with delay appears.

The optical signal having been subjected to a Fourier transform is input to the slab waveguide 225 through the allay waveguide 224. Therefore, the mode shape of the input side of the slab waveguide 225 becomes a sinc function.

Then, the slab waveguide 225 again applies a Fourier transform to the signal (sinc function) that has been subjected to the Fourier transform. This results in a spectrum of a square wave.

The optical signal that has been output from the slab waveguide 225 is output from some of the waveguides of the output waveguide 226.

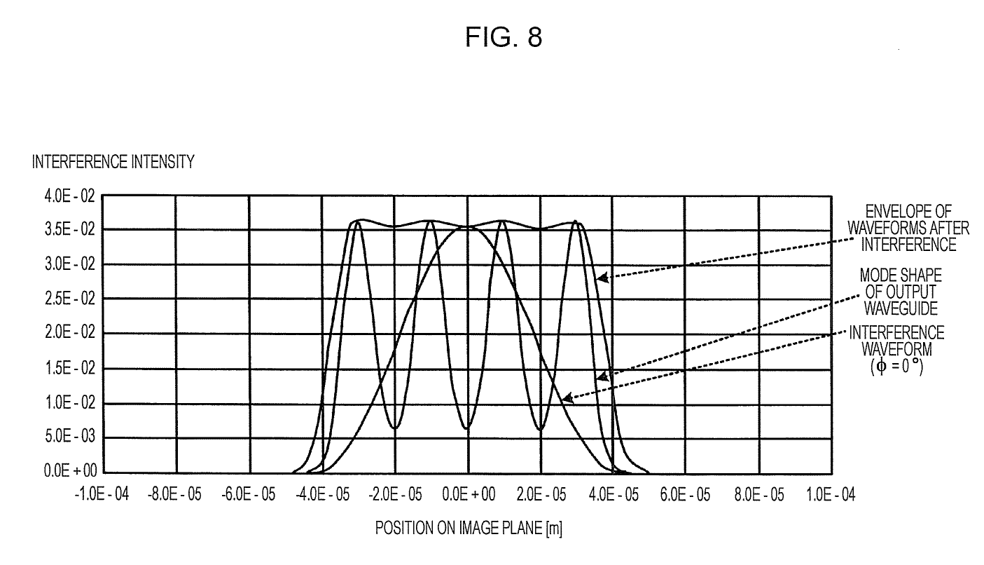

FIG. 8 illustrates waveforms after interference in the present embodiment.

With a square wave after interference as an envelope, obtained results reveal that portions where mutually intensifying interferences occur are high in the interference intensity, and that portions where mutually weakening interferences occur are low in the interference intensity. Because the envelope assumes a squared shape, even though an interference intensity of the output waveguide 226 is secured, “skirt components” (constituting stray components) occurring on the outside of the output waveguide are less than conventional cases.

As described above, according to the optical transmission system 30 in the present embodiment, since, in the demodulator 22, a sinc function type mode distribution is formed by providing the slab waveguide 223 and applying a Fourier transform to the square mode on the input side thereof, the propagation mode of the waveguide can be easily made a sinc function. This allows the inhibition of stray components occurring outside the output waveguides, with an envelope of interference waveforms as a square wave, and thus enables the reduction of loss of optical signals.

Furthermore, according to the optical transmission system 30 in the present embodiment, since the lengths of the waveguides in the allay waveguide 224 are made equal to each other, positional deviations of interference waveforms due to wavelength fluctuations of phase reference light can be inhibited.

The configuration of the demodulator 22 according to the present embodiment, (i.e., the configuration wherein the square mode distribution forming portion 222, the slab waveguide 223, the allay waveguide 224, the slab waveguide 225, and the output waveguide 226 are connected to each other in this order) can also be applied to other phase modulation methods (for example, a third embodiment to be described later).

### Second Embodiment

Next, an optical transmission system according to a second embodiment is described.

Hereinafter, regarding the optical transmission system according to the second embodiment, description is focused on differences from the optical transmission system according to the above-described first embodiment, wherein like items are omitted from description.

The optical transmission system according to the second embodiment is different in the configuration of the demodulator from that of the first embodiment.

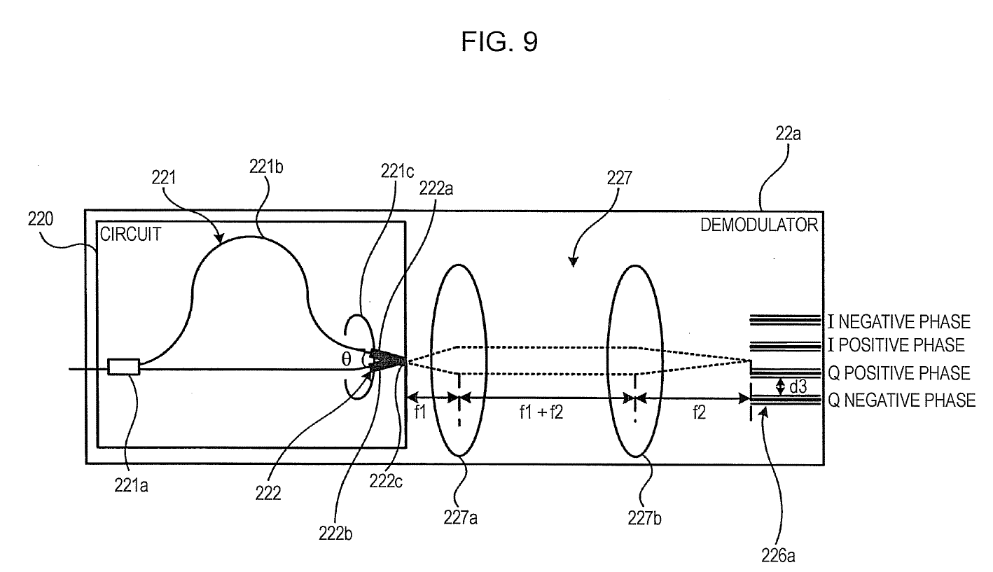

FIG. 9 illustrates a demodulator according to the second embodiment.

In the demodulator 22a according to the second embodiment, a space optical system is used instead of the slab waveguides. The demodulator 22a includes a circuit 220 having a branch delay portion 221 and a square mode distribution forming portion 222; a condenser lens system 227; and an output waveguide 226a.

The condenser lens system 227 includes a condenser lens 227a with a focal length f1 and a condenser lens 227b with a focal length f2.

The distance between the output portion 222c and the principal plane of the condenser lens 227a conforms to the focal length f1. The distance between the principal plane of the condenser lens 227b and the output waveguide 226a conforms to the focal length f2. The condenser lenses 227a and the 227b are arranged so that the distance between the condenser lens 227a and the condenser lens 227b conforms to (focal length f1+focal length f2). The output waveguide 226a has the same functions as those of the output waveguide 226.

It is here desirable that a distance d3 between two adjacent waveguides of the output waveguide 226a satisfy the relationship in the following expression (3) using the focal lengths f1 and f2.

4×d3=(f2/f1)×λ/θ (3)

That is, the expression (3) is one whose focal length f is replaced with the length L in the expression (2).

Now, functions of the demodulator 22a are explained in detail.

An optical signal output from the output portion 222c is branched into two optical signals at an angle θ, and made incident on the condenser lens 227a.

Upon passing through the condenser lens 227a, two light beams (collimated beams) are emitted to the condenser lens 227b in parallel with each other.

The light beams are subjected to a Fourier transform by the condenser lens 227b, resulting in a spectrum of a square wave. Thus, the same waveform as the envelope of interference waveforms illustrated in FIG. 8 can be obtained.

According to the optical transmission system according to the second embodiment, similar effects as those of the optical transmission system 30 according to the first embodiment are obtainable.

Furthermore, according to the optical transmission system in the second embodiment, since loss in the waveguides can be avoided, an optical transmission system with even more low loss can be achieved.

Meanwhile, the two lenses may also be integrated into a single lens. In this case, it is recommendable to form a condenser lens with a focal length of (f1×f2)/(f1+f2).

### Third Embodiment

Next, an optical transmission system according to a third embodiment is described.

Hereinafter, regarding the optical transmission system according to the third embodiment, the description is focused on differences from the optical transmission system according to the above-described first embodiment, wherein like items are omitted from description.

The optical transmission system according to the third embodiment is different in communications method from that of the optical transmission system 30 according to the first embodiment.

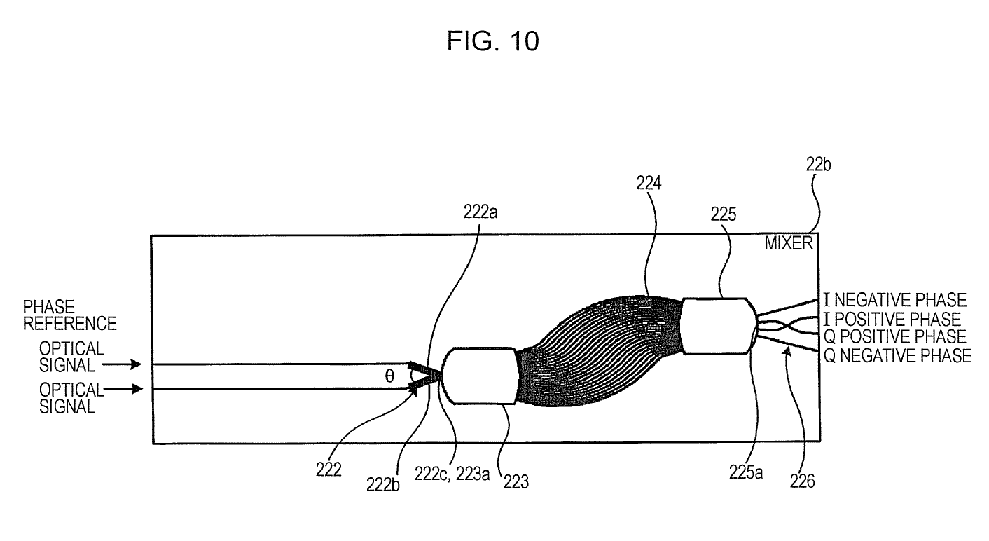

FIG. 10 illustrates a mixer according to the third embodiment.

A receiver according to the third embodiment has a mixer 22b applicable to the QPSK, instead of having the demodulator 22.

The mixer 22b is different from the demodulator 22 in that the mixer 22b has no branch delay portion 221, the phase reference signal is directly input to the mode conversion portions 222a, and an optical signal is directly input to the mode conversion portions 222b.

According to the optical transmission system in the third embodiment, similar effects as those of the optical transmission system 30 according to the first embodiment are obtainable.

As described above, although the optical transmission system has been explained based on the above-described embodiments, the present embodiments are not limited to the above-described ones. Components of any portion can be replaced with arbitrary components with like functions. Furthermore, other arbitrary constituent components or steps may be added to one or more of the above-described embodiments.

Moreover, one or more of the present embodiments may be a combination(s) of arbitrary two or more components (features) out of the above-described embodiments. For example, the condenser lens system 227 according to the second embodiment may be applied to the mixer 22b according to the third embodiment.

As stated above, the various embodiments may have additional steps, may be modified, or may be implemented in any preferred order, without departing from the scope of the present invention.

For example, in a photodetector, a step of detecting an optical signal may be added between the step S102 of creating the path of an interferometer and the step S104 of monitoring a signal characteristic.

As another example, after the step S102 of creating the interference path by a phase shift, a step of subjecting the interferometer path to an optical interference for creating an interfering signal may be added.

One or more of the specific embodiments can provide one or more technical advantages.

Technical advantages of one or more of the embodiments may include an improvement in signal quality in the receiver. More specifically, degradation of signal can be reduced or eliminated in the optical receiver by providing an automatic feedback control with respect to the delay interferometer.

Other technical advantages of one or more of the embodiments may include an accurate and efficient fine-adjustment of the delay interferometer by the monitoring of the quality reference of an optical signal.

Still other technical advantages of one or more of the embodiments may include an improvement in the DPSK/IMDPSK system.

Further technical advantages of one or more of the embodiments may include use of a quality reference for automatically adjusting an optical signal in the optical delay interferometer. This eliminates the need to manually adjust the optical delay interferometer, so that allowable error of fluctuation relating to a transmitter laser can be reduced, leading to an improved cost efficiency of the optical transmission system.

Yet further technical advantages of one or more of the embodiments may include the application of the DPSK/IMDPSK technique to an ultra-long haul (ULH) system based on reduction in allowable errors of nonlinear effect, and improvement in OSNR (optical signal-to-noise ratio) and in dispersion.

While the disclosed embodiments and the advantages thereof have been described in detail, it is to be understood that person skilled in the art can make various changes, additions, and eliminations without departing the spirit and the scope of the present invention clearly set forth in the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical circuit that converts a phase-modulated optical signal into intensity-modulated signal light in accordance with a phase, the optical circuit comprising:
a square mode distribution forming portion that forms a plurality of interfering signals each assuming a square mode shape, the interfering signals having respective phases shifted from each other by a certain angle;
a light interference portion that creates a signal having a certain mode distribution, from the interfering signal, and that applies a Fourier transform to the signal having the certain mode distribution; and
an output portion that has a plurality of waveguides each provided in correspondence with the phase and that outputs an optical signal that has been output from the light interference portion.

2. The optical circuit according to claim 1, wherein the light interference portion applies a first time Fourier transform to the interfering signal to create the signal having the certain mode distribution.

3. The optical circuit according to claim 1, wherein the square mode distribution forming portion comprises a pair of mode conversion portions that superimpose mode distributions of the optical signals together.

4. The optical circuit according to claim 3, wherein each of the mode conversion portions is constituted by Y-shaped light branching means for branching a respective one of input optical signals into two optical signals, the Y-shaped light branching means being overlaid on each other in a multistage manner.

5. The optical circuit according to claim 3, wherein output portions of optical signals in the mode conversion portions are connected to an input portion of the light interference portion in a state in which the output portions cross each other at a certain angle.

6. The optical circuit according to claim 1, wherein the light interference portion comprises:
a first slab waveguide;
a second slab waveguide; and
an allay waveguide connecting the first slab waveguide and the second slab waveguide.

7. The optical circuit according to claim 6, wherein the allay waveguide has a plurality of waveguides that are equal in length to each other.

8. The optical circuit according to claim 1, wherein the light interference portion has at least one lens that condenses light emitted from the square mode distribution forming portion on each of the waveguides.

9. The optical circuit according to claim 1, further comprising:
a branch delay portion that creates a delay signal obtained by delaying the optical signal by one symbol, and that guides the optical signal and the delay signal to the square mode distribution forming portion.

10. The optical circuit according to claim 1, further comprising:
a branch delay portion that guides the optical signal and a phase reference signal to the square mode distribution forming portion.

11. A receiver circuit that converts a phase-modulated optical signal into intensity-modulated signal light in accordance with a phase, the receiver circuit comprising:
an optical circuit including:
a square mode distribution forming portion that forms a plurality of interfering signals each assuming a square mode shape, the interfering signals having respective phases shifted from each other by a certain angle;
a light interference portion that creates a signal having a certain mode distribution, from the interfering signal, and that applies a Fourier transform to the signal having the certain mode distribution; and
an output waveguide that has a plurality of waveguides each provided in correspondence with the phase and that outputs optical signal output from the light interference portion; and
a balanced receiver that detects an optical signal that has been output from the output waveguide.
